(19) United States
(12) Patent Application Publication
(10) Pub. No.: US 2007/0051461 A1
(43) Pub. Date: Mar. 8, 2007

(54) Method for joining plastic work pieces

(76) Inventors: Wilhelm Pfleging, Bruchsal-Buchenau (DE); Oliver Baldus, Hockenheim (IT); Alessandro Baldini, Ladispoli (IT)

Correspondence Address: KLAUS J. BACH, 4407 TWIN OAKS DRIVE, MURRYSVILLE, PA, 15668, US

(21) Appl. No.: 11/593,717

(22) Filed: Nov. 7, 2006

Related U.S. Application Data
(63) Continuation-in-part of application No. PCT/EP05/04536, filed on Apr. 28, 2005.

(30) Foreign Application Priority Data
Jun. 24, 2004 (DE) 10 2004 030 619.2

(51) Int. Cl. B32B 37/00; B32B 37/06; B29C 65/00

(52) U.S. Cl. 156/272.8; 156/275.1; 156/257

(57) ABSTRACT

In a method for joining work pieces of transparent plastic material, wherein absorption layers are applied to an interface area between the work pieces to be joined and, wherein the work piece areas to be joined are firmly engaged and pressed together, and the interface area is subjected to laser radiation so that the absorption layer is heated and the work pieces are joined by welding, the absorption layer consists of carbon or gold with a thickness of 5 nm to 15 nm.

This is a Continuation-In-Part Application of International application PCT/EP2005/004536 filed Apr. 28, 2005 and claiming the priority of German application 10 2004 0303619.2 filed Jun. 24, 2004.

### BACKGROUND OF THE INVENTION

The invention resides in a method for joining plastic work pieces by laser welding wherein the assembled work pieces are transparent in the visible spectral range and are provided with an absorption layer.

Upon joining polymer workpieces by laser-based welding in accordance with the so-called radiographic welding method, an opaque polymer material is joined to a transparent polymer of the same type. In practice, for such tasks, radiation sources in the form of diode lasers have become the standard over Nd: YAG-lasers.

DE 195 10 493 A1 discloses a method for the welding of workpieces of plastic material wherein two workpieces are joined along a joint area where laser radiation passes through the first workpiece and into the second workpiece, whereby the workpiece are melted in the joint area and, upon cooling, the joint area is solidified. The method however has the disadvantage that color pigments have to be added to the two workpieces at different rates such that the material of one work piece is transparent for the spectrum of the laser beam and the other workpiece material is absorbent for the spectrum of the laser beam used.

In a variant of the beam penetration welding method by which also transparent polymers can be joined is the so-called clear-weld method which is presented in V. A. Kagan, N. M. Woosman, “Advantages of Clearweld Technology for Polyamides”, conference contribution to ICALEO, 2002, an absorber layer is disposed between the transparent components. This absorber layer (lacquer) is originally of a greenish color but, after exposure to the preferred wavelengths of 940 nm (diode laser) or 1064 nm (Nd:Yag Laser) becomes almost transparent. Its disadvantage resides in a long handling time which is mainly caused by the common method used for the application of the absorber layer.

From US 656 315 B2 and the state of the art referred to above, it is known to introduce a material into the joint area, which ensures the absorption of laser light. Whereas metals such as titanium are suitable only for the welding of glasses, inorganic materials such as pigments fibers, printing ink (which generally smut the work pieces to be joined) or selected organic coloring agents are used for the welding of plastic materials in order to provide for good absorption of the laser light in the joint area and, at the same time, to reduce straying thereof. The mentioned materials introduced into the joint area however must have a thickness of at least 1 μm in order to convert laser energy into heat. These methods are therefore not usable in connection with microstructures since the microstructures are detrimentally affected particularly by becoming deformed or forming fractures.

It is the object of the present invention to provide a method for joining workpieces of plastic material wherein the joined workpiece is transparent in the visible range and which does not have the disadvantages mentioned above. Particularly, the method is to facilitate the joining of microstructured plastic components without causing damage to the microstructures.

### SUMMARY OF THE INVENTION

In a method for joining work pieces of transparent plastic material, wherein absorption layers are applied to an interface area between the work pieces to be joined and, wherein the work piece areas to be joined are firmly engaged and pressed together, and the interface area is subjected to laser radiation so that the absorption layer is heated and the work pieces are joined by welding, the absorption layer consists of carbon or gold with a thickness of 5 nm to 15 nm.

The pressure with which the workpieces are pressed together is between 0.1 MPa and 1 MPa, preferably between 0.3 MPa and 0.7 MPa and the absorption layers are disposed in each case between two work pieces.

Although gold is not transparent, but it is well suitable as absorption layer for the welding procedure. By vacuum vapor deposition processes (filament vaporization, spatter-coating) or by a spray process, thin transparent layers can be deposited on transparent polymers. In a particular embodiment, the absorption layers are deposited over a contact mask in order to make only selected areas subject to the subsequent welding process. An alternative embodiment for a selective structuring of the absorption layer resides in the use of UV laser microablation of a wavelength of the ablation laser of between 250 nm and 400 nm, particularly preferably about 355 nm. Many polymers are transparent for lasers of this wavelength so that a selective structuring of the absorption layers with resolutions in the μm range is possible.

Then one of the absorption layers is exposed to a first laser whose radiation is focused onto the absorption layer. The power output of this laser is so selected that the absorption layer is heated such that the two workpieces in contact with the absorption layer are interconnected. The wavelength of the first laser is between 800 nm and 1200 nm, preferably between 920 nm and 960 nm and particularly preferably about 940 nm (diode laser).

If several polymer workpieces are to be joined, additional absorption layer are disposed between adjacent workpieces to be joined and are subjected to laser beam irradiation. In a particular embodiment, one workpiece remains free of an absorption layer coating and the laser beam is directed through this workpiece onto the absorption layer.

After cooling and elimination of the compression pressure, the joint workpiece is removed from the manufacturing tool.

Particularly suitable for the joining method proposed herein are the following plastic materials; polymethylmethacrylate (PMMA), polypropylene (PP), Polycarbonate (PC), cycloolefincopolymer (COC), Polyvinyl difluoride (PVDF), polyetheretherketone (PEEK), polysulfane (POM), polyethylene (PE), polymethane (PUR), polyether sulfone (PES), and Teflon ®, including particularly polytetra fluorethylene (PTFE).

In a preferred embodiment, the laser beam is moved by a scanner lens normal to the absorption layer across the surface of the workpieces to be joined. For the present welding procedure speeds between 1 and 1000 mm/s, preferably between 10 and 100 mm/s are suitable. The laser power output is controlled online using a pyrometer in order to hold the temperature constant in an interaction range around the absorption layer. For the plastic material PMMA for example the suitable temperature is for example in the range of the glass temperature of the polymer at about 105° C. Already deviations of ± 5° may result in faulty connections.

The laser beam is moved over the interface area of the transparent polymer workpieces which are pressed against each other during the joining process with a pressure of preferably 0.1-10 MPa (1-10 bar). Transverse cuts of joined workpieces of PMMA or PVDF show that, with the present method, the thermally affected area can be limited to a few micrometers (μm). Consequently, micro-structured PP- and PVDF foils of a thickness of 200-250 μm can be welded together without causing any significant damage or, respectively, deformation of the structures. As a result, polymers of a thickness of 10 μm to 10 cm can be interconnected without losing their transparency in the visible light range.

Almost all known polymers have a high radiation absorption at the wavelength of the CO₂ laser radiation (9-11 μm) . As a result, the polymers can be cut with high precision by a third laser, which has a wavelength between 9 μm and 11 μm and with a minimal cutting groove width of ca. 50 μm. The cutting grooves furthermore have steep edges. Since the laser treatment processes are thermal processes, a thin melt film is formed at the edges which smoothens the edges. The structuring is obtained in this case not by ablation or, respectively, material removal which generally results in melt displacement and contamination and debris formation as well as inclined edge areas, but by cutting structures closed at one or both sides, or the forming of stepped structures however are possible only in connection with laser beam welding as proposed herein.

In an alternative embodiment, the polymers are cut by sublimation via UV-radiation wherein so-called sublimation welding takes place. Herefor, a third laser with a wavelength between 150 nm and 400 nm such as a Nd:YAG-laser (266 nm, 355 nm) is suitable, since this laser beam source can be operated at high pulse frequency. Also, a third laser with a wavelength between 150 nm and 400 nm can be used in order to achieve a three-dimensional material removal by means of UV-laser radiation. For this material removal by sublimation preferably an Excimer laser (wavelength 157 nm, 193 nm or respectively, 248 nm) or also a ND:YAG laser (266 nm, 355 nm) is preferably used.

The combination of cutting and welding for producing a three-dimensional micro-fluidic system results in high shape accuracy with steep flanks and high edge qualities as well as little roughness. The method according to the invention comprises an overall fully laser-based process, which can be performed inexpensively, rapidly and in a simple manner. There is only a relatively small heat input into the material so that the microstructures are not damaged in the process. In this way, microstructured polymer foils can be built up in layer form.

From http://www.uni-stuttgart.de/hsg-imat/aif452.pdf, pages 82-91 from Jun. 27, 2003 , it is apparent that the known laser beam workpiece penetration welding cannot be used in connection with microstructures without any changes since the following damages will occur on the microstructures:

Deformation of the micro-channels, formation of pores and fractures and, respectively, breaking of the weld joints as a result of thermally induced inner stresses.

The laser welding of polymers offers the possibility to manufacture microstructured components efficiently. It is a great advantage of the laser-based welding of polymers over classic joining methods such as cementing, resistance heating, ultrasound or vibration welding that it can be done in a contact-free and flexible manner. The energy input can occur, depending on the method variation, locally with high flexibility and precision and high reproducibility.

In micro-engineering and micro-fluid systems or, respectively, bio-analysis, no laser welding technology has been established which permits a secure joining of transparent polymer microstructured components without causing damage to the microstructures. This however is exactly what is achieved by the present invention. With the combination of laser beam cutting and laser beam welding a process becomes possible which may be termed Rapid Manufacturing. Hereby, functional components of almost any polymer material can be manufactured in a minute tact.

The method according to the invention can be employed in many ways:

The following examples are presented:
manufacture of micro-mixers,
bio-analysis such as covering of CE chips,
PA filters in the automotive field
PC glasses
PA electronic keys
POM-housings for pumps and turbines, plastic windows, etc . . .

The invention(provides particularly the following advantages:
joining of transparent and microstructured polymers without damage to their microstructures;
almost any type of plastic materials (polymer) can be used since these materials are generally transparent for radiation around 940 nm,
thick and thin polymer components can be joined (for example, foils with a thickness of 200 μm),
functional components can be rapidly manufactured.

Below, the invention will be described in greater detail on the basis of embodiments thereof with reference to the accompanying drawings.

### BRIEF DESCRIPTION OF THE DRAWINGS

FIG. 1 shows schematically the joining of workpieces of plastic material;

FIG. 2 shows schematically the joining of microstructured workpieces of plastic,

FIG. 3 shows the joining of two workpieces by alternating scanning with a laser beam,

FIG. 4 shows the joining of a stack of workpieces by alternating scanning with a laser beam,

FIG. 5a shows schematically a three-dimensional channel system for a microfluid structure,

FIG. 5b shows schematically a micro-mixer, both the structure of FIG. 5a and that of FIG. 5b being made in accordance with the method of the invention,

FIG. 6 shows an arrangement for determining the tensile strength of a connecting joint between two components, and

FIG. 7 shows the tensile strength of a joint between two workpieces of PMMA depending on the thickness of an absorption layer of carbon.

### DESCRIPTION OF PREFERRED EMBODIMENTS

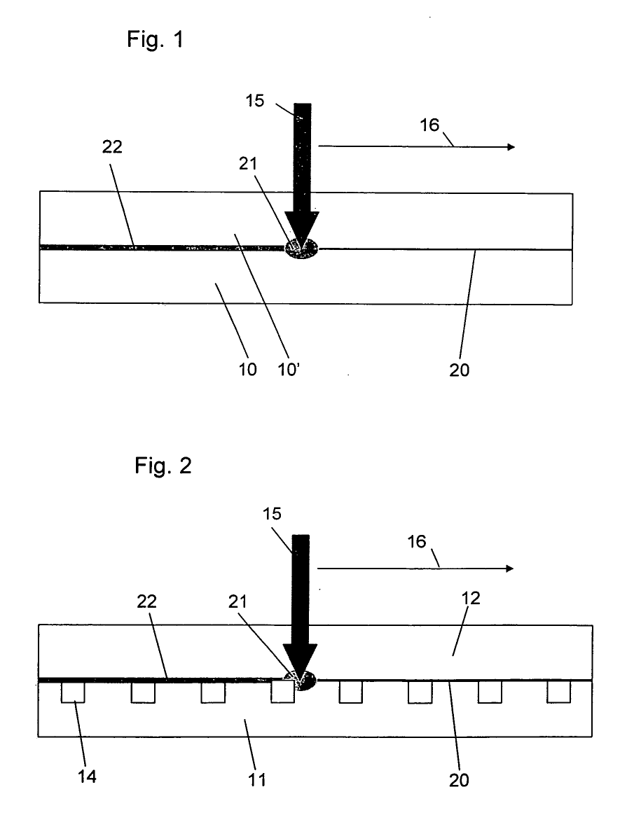

FIG. 1 shows schematically the method according to the invention for the joining of the two workpieces 10, 10″ of plastic material wherein an absorption layer 20 of carbon is applied to the workpiece 10. A laser beam 15 with a wavelength of 940 nm, which is focused onto the absorption layer 20 is moved along a path 16 (scanned). The scanning speed in the case of PMMA was 20-50 mm/s;

The scanning staggering was 200 μm.

The power of the laser beam 15 was so selected that the temperature in the laser-influenced zone 21 exceeds the glass temperature of the plastic (PMMA; 105° C., PC; 160° C.), whereby the absorption layer 20 is heated and, as a result, the two workpieces 10, 10′ are interconnected via the joining zone 22. During the laser scan the two workpieces were pressed together with a pressure of between 0.3 and 0.7 MPa (3 bar and 7 bar).

FIG. 2 shows a transparent microstructured polymer foil or plate 11 being joined by the method according to the invention to another polymer foil or plate 12 which, optionally, may also be microstructured like in accordance with FIG. 1. The microstructures are unaffected by the procedure.

Experiments with plates (thickness 1-2 nm) or foils (thickness about 200 μm) of PMMA, PP, PC, COC, PVDF, PEEK, PSU, PA and PTFE (Teflon ®) were performed successfully. For this purpose, the plastic plates or, respectively, foils mentioned were coated in a vacuum filament vaporization apparatus with carbon of a layer thickness in the nm range. The transparent polymers used remained transparent after completion of the joining process.

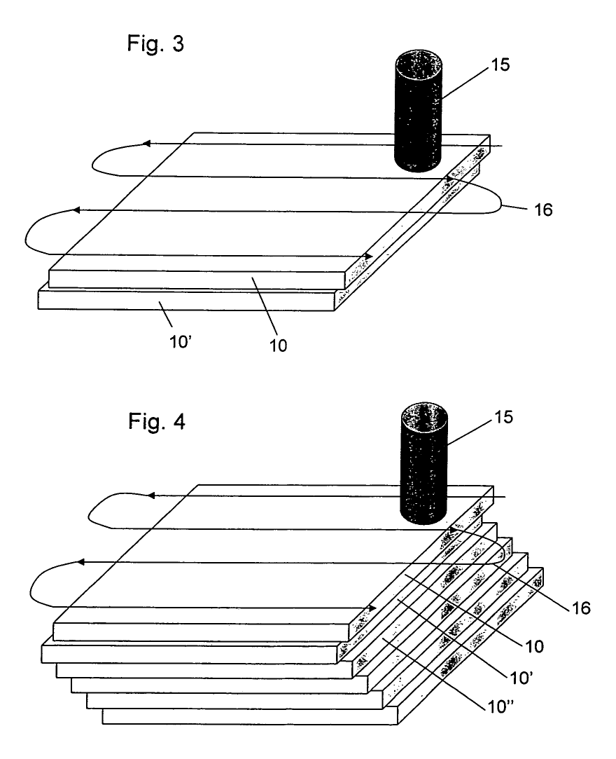

As shown in FIG. 3, for joining two polymer workpieces the laser beam (that is, the focus location thereof) is moved (scanned) alternatingly over the interface area between the two polymer workpieces, wherein a scanning displacement of 1-1000 μm is selected. Since the polymers are transparent for the laser beam and absorption takes place only in the interface areas or, respectively, in the absorption layers, the method according to the invention permits stacking of the polymer plates or, respectively, foils and their jointure with a connected workpiece as shown in FIG. 4.

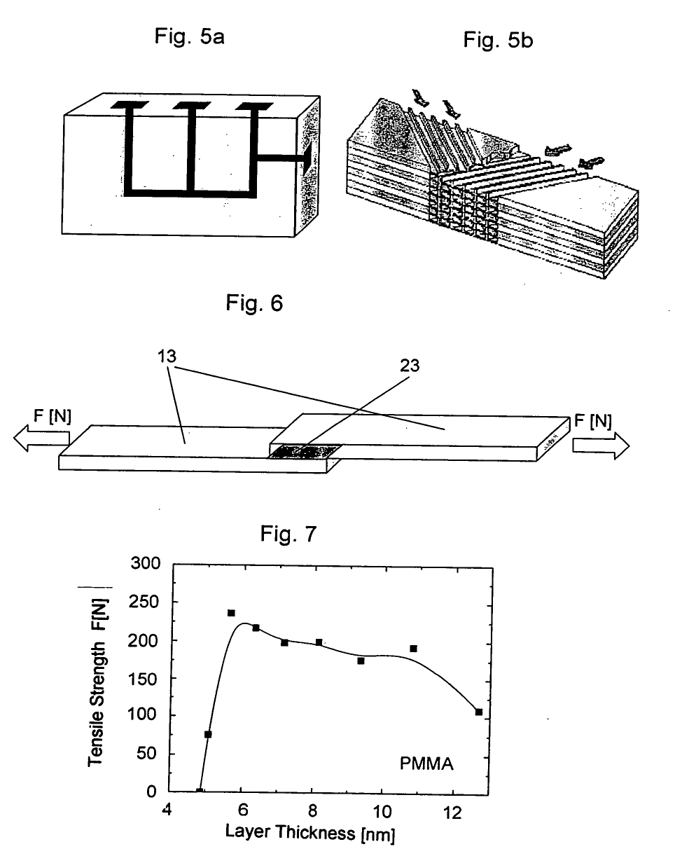

The method according to the invention is suitable for example for making three-dimensional structures as they are used in microfluid structures (see FIG. 5a) or micro-process engineering (see FIG. 5b).

The connections obtained are very stable as tests have shown made by tension testing machines of an arrangement according to FIG. 6. The tensile strength of the joined workpieces may, depending on the welding parameters, equal the tensile strength of the start-out materials.

FIG. 7 shows that the thickness of the absorption layer 20 is essential for forming a good joint between the workpieces. It was found that there is an optimal thickness for the absorption layer 20 of carbon in the area between 5 nm and 15 nm.

What is claimed is:

1. A method for joining work pieces of plastic wherein the work pieces being joined are transparent in the visible frequency range, said method comprising the steps of:
a) providing work pieces of a plastic material which is transparent in the visible light frequency range and at a wave-length of a first laser,
b) applying in each case an absorption layer to the workpieces wherein at most one workpiece remains uncoated,
c) compressing the workpieces, each absorption layer being disposed between two workpieces which are pressed together,
d) subjecting one of the absorption layers to a laser radiation from a first laser whose power output is so selected that the absorption layer is heated thereby and as a result, the two workpiece areas adjacent the absorption layer are interconnected,
e) if necessary, repeating the step d) with at least one additional absorption layer,
f) cooling the workpiece and removing the engagement pressure, and
g) removing the combined work pieces, said absorption layer consisting of one of carbon and gold and having a thickness of between 5 nm and 15 nm.

2. A method according to claim 1, wherein the absorption layer is deposited on the workpieces by one of vapor deposition and spraying.

3. A method according to claim 1, wherein at least one of the absorption layers is applied to the workpiece through a structured mask.

4. A method according to claim 1, wherein at least one absorption layer applied to a workpiece is structured by laser ablation using a second laser.

5. A method according to claim 4, wherein the wavelength of the second laser is between 250 nm and 400 nm.

6. A method according to claim 1, wherein the wavelength of the first laser is between 800 nm and 1200 nm.

7. A method according to claim 1, wherein the power output of the first laser is controlled by a pyrometer.

8. A method according to claim 1, wherein the plastic material consists of one of the following materials; polymethylmethacrylate (PMMA), polypropylene (PP), Polycarbonate (PC), cycloolefincopolymer (COC), Polyvinyl difluoride (PVDF), polyether-ether ketone(PEEK), polysulfane (POM), polyethylene (PE), polymethane (PUR), polyether sulfone (PES), and Teflon®, including particularly poly-tetra-fluorethylene (PTFE).

9. A method according to claim 1, wherein the thickness of the workpiece is between 10 μm and 10 cm.

10. A method according to claim 1, wherein at least one of the workpieces includes microstructures.

11. A method according to claim 10, wherein the microstructures are applied to the workpiece by a third laser.

12. A method according to claim 11, wherein the third laser has a wavelength of between one of 9 μm and 11 μm and 150 nm and 400 nm.
